(19) United States
(12) Patent Application Publication
(10) Pub. No.: US 2025/0101544 A1
(43) Pub. Date: Mar. 27, 2025

(54) LITHIUM RECOVERY FROM BRINE

(71) Applicant: AVONLEA TECHNOLOGY HOLDINGS CORP., Calgary (CA)

(72) Inventors: Ronald Otto LINCZ, Calgary (CA); Douglas James BRETT, MD Foothills (CA); Roy Jones Abocot TESORERO, Calgary (CA)

(73) Assignee: AVONLEA TECHNOLOGY HOLDINGS CORP., Calgary, AB (CA)

(21) Appl. No.: 18/832,838

(22) PCT Filed: Jan. 25, 2023
(86) PCT No.: PCT/IB2023/050641

§ 371 Date: Jul. 24, 2024

Related U.S. Application Data
(60) Provisional application No. 63/267,149, filed on Jan. 26, 2022.

(51) Int. Cl. C22B 26/12; C02F 1/34; C02F 1/52; C02F 101/10; C22B 3/02; C22B 3/44; C22B 26/22

(52) U.S. Cl. CPC C22B 26/12; C02F 1/34; C02F 1/52; C22B 3/02; C22B 3/44; C22B 26/22; C02F 2101/10; C02F 2301/046

(57) ABSTRACT

An example of a method and apparatus to remove a waste element from a brine solution is provided. The method involves receiving the brine solution comprising dissolved lithium and a waste element. The method further involves pumping the brine solution into a cavitation chamber. In addition, the method involves adding a combining ion to the brine solution. The method involves reducing a pressure of the brine solution in the cavitation chamber as the brine solution moves away from an inlet. The pressure is reduced to below a fluid vapor pressure of the brine solution to create micro-bubbles. Furthermore, the method involves collapsing the micro-bubbles to generate a localized energy release to accelerate the formation of a waste precipitate to provide a mixture of the brine solution and the waste precipitate. The method involves filtering the waste precipitate to remove the waste element from the mixture.

### BACKGROUND

The demand for lithium has sharply increased due to the global demand of lithium-ion batteries. Lithium is currently being recovered commercially from both mineral ores and brines. However, focus on brine extractions technologies is ever increasing as they are known to have more reserves than ores.

The main source of lithium brines comes from salars located in Argentina, Bolivia, and Chile in South America. Other lower concentration brines exist globally, including oilfield brines and geothermal brines. Over the last several decades, conventional extraction of lithium from brines involves concentrating the lithium in the brine through solar evaporation followed by a variety of extraction methods. This conventional method uses vast areas of land, a significant amount of time, an enormous waste of water resources (evaporation) in an arid area where water is extremely scarce, and significant upfront capital costs with the realization of revenue taking several years from the project start-up.

### BRIEF DESCRIPTION OF THE DRAWINGS

Reference will now be made, by way of example only, to the accompanying drawings in which:

FIG. 1 is a schematic representation of the components of an example of an apparatus to extract lithium from a brine solution;

FIG. 2 is a schematic representation of the components of another example of an apparatus to extract lithium from a brine solution;

FIG. 3 is a flowchart of an example process of extracting lithium from a brine solution; and

FIG. 4 is a flowchart of another example process of extracting lithium from a brine solution.

### DETAILED DESCRIPTION

This process applies hydrodynamic cavitation to the fluid being treated at a level of intensity that chemical reactions will be initiated and/or accelerated without using high pressure and temperature environmental conditions to impose the reactions. This significantly reduces the time and costs normally associated with this chemical process. This process is designed to reduce the chemical reaction time and costs associated with the multiple process approaches associated with the extraction of lithium from brine. Once extracted, lithium may have multiple applications, such as for lithium ion batteries, glass, ceramics, lithium grease, air conditioners, medical uses, polymers, and metallurgy. Lithium metal is not stable in air. However, lithium can be a component of several stable compounds, such as lithium carbonate, lithium hydroxide, lithium phosphate, and lithium chloride.

Conventional methods of extracting lithium from a brine solution involves evaporating large quantities of brine solution in pools to increase the concentration of lithium in the brine solution. Accordingly, this process involves large areas of land to provide large surface areas for evaporation. In addition, the process typically involves locations in arid places to reduce the amount of energy used as well as to increase the rate of evaporation. To accelerate lithium extraction from brine solutions, such as brine solutions with lower concentrations of dissolved lithium, various processes may be used to increase recovery efficiencies, reduce land requirement, reduce water wastage, and shorten the return-on-investment timeline. For example, the lithium extraction from a brine solution may include chemical precipitation, adsorption with inorganic ion exchange sorbents, solvent extraction, phosphate precipitation, and concentration with nano-filtration and membrane electrolysis.

An apparatus and process to extract lithium from a brine solution using hydrodynamic cavitation is provided. Hydrodynamic cavitation is a process where a fluid experiences a pressure drop across a system. In particular, the hydrodynamic cavitation system creates micro-bubbles in fluid through the rapid decrease of localized pressure in a fluid flow system below the fluid vapor pressure. As the fluid flow system returns to a pressure above the fluid vapor pressure, the subsequent collapse of the micro-bubbles creates a very high localized energy release in the form of extremely elevated pressures and temperatures, within a very short period of time. During this process, several conditions or reactions are created which further accelerate the rate of chemical reactions. For example, free radicals are created from the disassociation of vapor trapped within the imploding micro-bubble. Free radicals contain unpaired orbital electrons, making them highly reactive to enhance chemical reaction rates. Mass transfer rates (precipitation mechanism) and interfacial area contact are also enhanced due to the locally created shock waves and associated high temperatures and pressures. For this reason, hydrodynamic cavitation reaction in a controlled environment may be used to enhance chemical and physical reactions partially due to the energy and heat release.

Accordingly, the apparatus and method introduce brine solutions containing dissolved lithium into a cavitation chamber to create high pressure and high temperature environments at the molecular level. This provides a sufficient energy release to accelerate chemical reactions to extract lithium from lower concertation brine solutions quickly, efficiently, and cost effectively. Hydrodynamic cavitation will be used to accelerate precipitation reactions and can be used to selectively remove components of the brine solution in a manner that can increase the yield of lithium.

For example, removal of non-lithium ions, also referred to as waste elements, that interfere with the yield of the lithium extracted can be carried out by forming precipitates with the waste elements. Accordingly, the waste elements may be removed from the brine solution without removal of dissolved lithium ions in the brine solution. Precipitation of specific elements, such as waste elements or lithium, may be carried out by adding a predetermined combining ion that forms a precipitate of a specific target ion based on the solubility under specific conditions of temperature, pressure, pH, and ionic strengths within the brine solution. It is to be appreciated by a person of skill with the benefit of this description that where precipitation of the element is inefficient or not practical, other chemical extraction processes may be carried out, such as adsorption with inorganic ion exchange sorbents, solvent extraction, phosphate precipitation, and concentration with nano-filtration and membrane electrolysis.

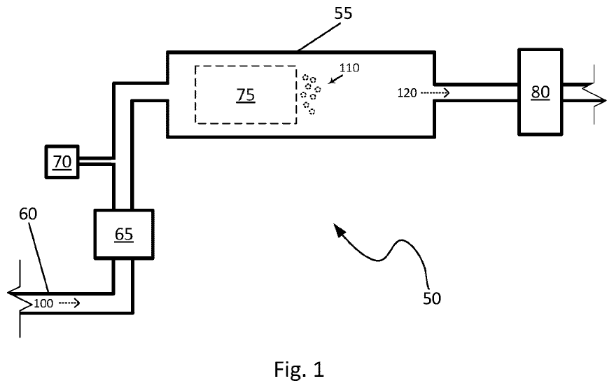

Referring to FIG. 1, a schematic representation of an apparatus 50 to extract lithium from a brine solution 100 containing dissolved lithium and a waste element is generally shown. The apparatus 50 may include additional components, such as various additional filters or processing devices. For example, the apparatus 50 may include flow controllers, additional pumps, or other mechanical features to assist with the flow of the brine solution through the apparatus 50. In other examples, the apparatus 50 may further include heaters or additional injectors to add further chemicals into the brine solution flow to further assist with the separation of the dissolved lithium from the waste element in the brine solution. In the present example, the apparatus 50 includes a cavitation chamber 55, an inlet 60 at which the brine solution 100 is received, a pump 65, an injector 70, a micro-bubble generator 75, and a filtration unit 80.

In the present example, the cavitation chamber 55 is not particularly limited. In particular, the size of the cavitation chamber 55 is not limited and any size suitable for an application with predetermined target flow rates may be used. It is to be appreciated by a person of skill with the benefit of this description that the cavitation chamber 55 is also not limited to any design. In the present example, the cavitation chamber 55 has a capacity of approximately 0.5 L to 1.0 L. In other examples, the cavitation chamber 55 may be significantly larger for applications involving the processing of larger volumes of brine solution 100 from multiple larger deposits where the extraction capacity is higher. Alternatively, additional cavitation chambers may be added to operate in parallel with each other to increase the flow capacity. In other examples, where the apparatus 50 is to be used for smaller batches of brine solution at a processing facility, the cavitation chamber 55 may be smaller.

The construction of the cavitation chamber 55, such as the walls, is not particularly limited and may use a wide variety of materials. In the present example, the cavitation chamber 55 is a steel chamber. The cavitation chamber 55 may be lined internally with an anti-corrosion layer and include an insulating layer. In other examples, the cavitation chamber 55 may be constructed from other materials that have the appropriate mechanical properties to withstand the operating conditions of the apparatus, such as temperatures and pressures. Other materials may include plastic or other metals and metal alloys such as stainless steel. Furthermore, it is to be appreciated by a person of skill with the benefit of this description that in some examples, the cavitation chamber 55 may be a single unitary body constructed from the same material, such as from a molding process. In other examples, the cavitation chamber 55 may be manufactured from several pieces bolted or welded together.

The inlet 60 is to receive the brine solution 100 from a source. In the present example, the inlet 60 may be a connector to an external pumping station that pumps a brine solution from a reservoir into the apparatus 50. In other examples, the inlet 60 may be a hose or pipe in a brine solution reservoir. The brine solution 100 received at the inlet 60 is not particularly limited and may include dissolved lithium ions and at least one waste element dissolved in an aqueous solution. In some examples, the brine solution 100 may be mixed with other components that are not soluble with water to form a suspension of different components, such as an emulsion. Accordingly, the emulsion received at the inlet 60 may be subjected to pre-processing steps to extract the aqueous component. The pre-processing is not limited and may include a pre-filter or other separation technique.

The pump 65 is to pump the brine solution 100 from the inlet 60 to the cavitation chamber 55. In the present example, the pump 65 is to maintain the flow of the brine solution 100 at a predetermined pressure that can generate micro-bubbles 110. The pump 65 is not particularly limited and may be any type of pump capable of pumping the brine solution 100 from the inlet to the cavitation chamber 55 and maintain the predetermined pressure. In the present example, the pump 65 is a variable frequency drive pump. In other examples, the pump 65 may be a rotary pump, or any other style of pump capable of pumping consistent volumes at a stable pressure. It is to be appreciated by a person of skill with the benefit of this description that the pump 65 may be modified or omitted if the brine solution 100 is to be received at the inlet 60 at a pressure that is substantially the same as or greater than the predetermined pressure. In some examples, the pump 65 may also be used to draw in the brine solution 100 at the inlet 60, such as from a standing pool of brine solution.

In the present example, a controller (not shown) may be used to control the operation of the pump 65. In particular, the controller may be connected to sensors at various locations along a brine solution line, such as a pressure sensor near the cavitation chamber 55, and control the operation of the pump 65 to maintain a substantially constant target pressure at or about the predetermined pressure. The sensors may provide data to the controller, which in turn can send control signals to control the pump 65 to adjust or maintain the pressure of the brine solution 100 entering the cavitation chamber 55. The control signals are not limited and may be different depending on the pump 65. In the present example, the pump 65 is a variable frequency drive pump. Accordingly, the processor may send commands to control the pump speed depending on the pressure measure by a sensor. The pump speed may be increased or decreased to maintain the pressure of the brine solution 100. Accordingly, the pump 65 and controller may operate together to maintain a fluid pressure at the predetermined target pressure. The predetermined target pressure is not particularly limited and may vary from one application to another depending on the composition of the brine solution 100 which may affect the chemical and physical characteristics.

It is to be appreciated by a person of skill in the art with the benefit of this description that the cavitation chamber 55 and the micro-bubble generator 75 are designed to operate within a range of parameters, such as within a range of target pressures of the fluid being introduced into the cavitation chamber 55. By maintaining the pressure and flow rate of the brine solution 100 at about the target values or close to the target values, the efficiency of the micro-bubble generator 75 is greater than if the pressure is higher or lower than the target pressure. In other examples, instead of using a processor as the controller, a mechanical or analog replacement of the controller may be substituted. The mechanical pressure gauge may be used to measure the pressure of the brine solution 100 on either side of the pump 65 to control the pump speed when threshold values are reached.

In examples where the pressure of the brine solution 100 at the inlet 60 is greater than the predetermined target pressure of the brine solution 100 into the cavitation chamber 55, the pump 65 may be replaced with a mechanical pressure regulator to reduce the pressure of the brine solution 100 as it enters the cavitation chamber 55. In further examples, the apparatus 50 may include both a pump 65 and a pressure regulator to accommodate input pressures that may be over or under the target pressure of the brine solution 100 into the cavitation chamber 55. Accordingly, by controlling the pressure of the brine solution 100 as it enters the cavitation chamber 55, the apparatus 50 may be used in a wide variety of applications that may have varying pressures.

The injector 70 is disposed on the line carrying the brine solution 100 from the inlet 60 to the cavitation chamber 55. In the present example, the injector 70 is to inject an ion solution into the flow of the brine solution 100. In particular, the ion solution includes a combining ion that can form a precipitate with the waste element dissolved in the brine solution 100. The ion solution is not particularly limited and the combining ion may be selected from a plurality of ions to target the waste element.

For example, if the brine solution 100 received at the inlet 60 includes dissolved magnesium as a waste element, the injector 70 may introduce hydroxide ions and phosphate ions. In other examples, the brine solution 100 received at the inlet 60 may also include dissolved calcium. Accordingly, the injector 70 may introduce hydroxide ions, carbonate ions, and oxalate ions. It is to be understood by a person of skill with the benefit of this description that in some examples, the ion solution may include multiple different ions to combine with multiple waste elements dissolved in the brine solution 100. The combination of combining ions may be injected simultaneously or separately in series by the injector 70. By injecting the combining ions separately, such as by opening and closing different reservoirs from which the injector 70 draws ion solution. To reduce the likelihood of forming a precipitate with the dissolved lithium ions in the brine solution 100, the combining ions are to be selected such that the solubility of the waste element precipitate is significantly lower than any lithium precipitate with the combining ion. Other conditions, such as the temperature and acidity of the brine solution 100, may be varied to provide more favorable conditions to precipitate the waste elements out of the brine solution 100 without forming a lithium precipitate.

The micro-bubble generator 75 is disposed within the cavitation chamber 55. The micro-bubble generator 75 creates micro-bubbles 110 by reducing the pressure in localized regions of the brine solution 100 as it passes through the micro-bubble generator 75. The pressure in the localized regions is to be reduced to below the vapor pressure of the brine solution 100. The manner by which the micro-bubble generator 75 reduces localized pressure in the regions is not particularly limited. For example, the micro-bubble generator 75 may be a hydrodynamic cavitation reactor having a blade moving at a high speed through the brine solution 100 to create localized regions of low pressure as the blade passes through.

Once the micro-bubbles 110 form, they leave the localized regions of low pressure and collapse as they return to the higher pressure regions of the brine solution 100. Upon collapsing, the micro-bubbles 110 release localized energy that can accelerate or cause the formation of precipitates from the waste element and combining ion, such as the formation of a waste precipitate of the combining ion with the dissolved waste element. Once the precipitate is formed, the precipitate may be in small granular pieces as a result of the localized nature of the micro-bubble collapsing to form a mixture 120 of brine solution and precipitate before leaving the cavitation chamber 55.

The filtration unit 80 is to process the mixture 120 of brine solution and precipitate from the cavitation chamber 55. Continuing with the current example where the mixture includes a waste precipitate, the filtration unit 80 is to remove the waste precipitate from the mixture provided from the cavitation chamber 55. The filtration unit 80 is not particularly limited. For example, the filtration unit 80 may be a paper filter, a ceramic filter, a polypropylene filter, a polyester filter, a nylon filter, a Teflon filter, a cotton filter, or a wool filter. In further examples, the filtration unit 80 may include multiple filters that are separated in different compartments to capture different precipitates if the injector 70 is capable of injecting different combining ions. The flow of the mixture 120 from the cavitation chamber 55 may be directed to different filters using valves that may be manually manipulated or controlled by a processor in an automated system.

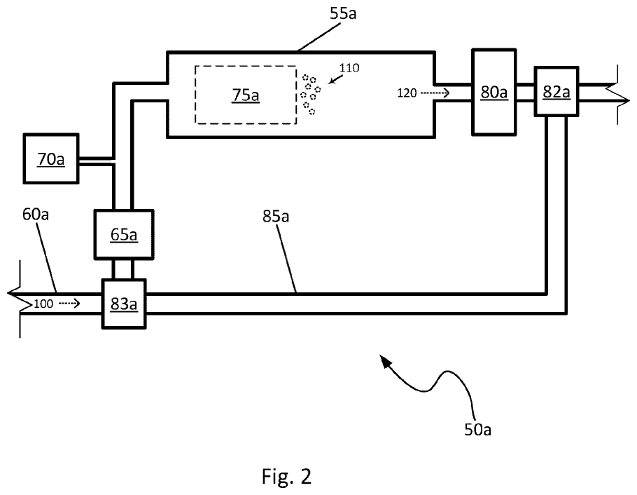

Referring to FIG. 2, another example an apparatus 50a to extract lithium from a brine solution 100 containing dissolved lithium and a waste element is generally shown. Like components of the apparatus 50a bear like reference to their counterparts in the apparatus 50, except followed by the suffix “a”. The apparatus 50a includes a cavitation chamber 55a, an inlet 60a at which the brine solution 100 is received, a pump 65a, an injector 70a, a micro-bubble generator 75a, a filtration unit 80a, valves 82a and 83a, and a recirculation path 85a.

In the present example, the cavitation chamber 55a, the pump 65a, the injector 70a, and the micro-bubble generator 75a may be substantially similar or identical to the counterparts in the apparatus 50. In particular, the cavitation chamber 55a is to receive a brine solution 100 via the inlet 60a. The brine solution 100 is pumped to the cavitation chamber 55a with the pump 65a. Along the path from the inlet 60a to the cavitation chamber 55a, an injector 70a is to inject an ion solution with a combining ion into the flow of the brine solution 100. Micro-bubbles 110 are generated with the micro-bubble generator 75a and the subsequent collapse of the micro-bubbles creates a mixture 120 of brine solution and waste precipitate.

The recirculation path 85a provides a fluid connection from the outlet of the filtration unit 80a back to the inlet 60a of the apparatus 50a. Accordingly, the recirculation path 85a receives the brine solution 100 with the waste precipitate removed and delivers it back to the inlet 60a where the brine solution 100 may be re-processed in the cavitation chamber 55a. This provides multiple passes of the brine solution 100 to allow for more thorough removal of the waste element from the brine solution 100.

The valves 82a and 83a are to control the flow of the brine solution through the apparatus 50a. The valves 82a and 83a are not particularly limited and may be three-way valves or other types of valves capable of controlling the flow of the brine solution 100 at the various locations. For example, the valve 82a may direct the flow of the brine solution 100 to the recirculation path 85a or to an outlet of the apparatus 50a for further processing by downstream devices or for disposal. The valve 83a may be used to control the brine solution 100 delivered to the cavitation chamber 55a. For example, the valve 83a may stop the flow of the brine solution 100 from the inlet 60a and deliver recirculated brine solution from the recirculation path 85a. Alternatively, the valve 83a may stop the flow of brine solution 100 from the recirculation path 85a and provide brine solution 100 received at the inlet 60a to the cavitation chamber 55a. In a further example, the valve 83a may mix some recirculated brine solution with brine solution 100 received at the inlet 60a.

Although the recirculation path 85a is shown to be a simple line connecting the valve 82a to the valve 83a, it is to be appreciated by a person of skill with the benefit of this description that the recirculation path 85a may include additional components. For example, the recirculation path 85a may include a pump to facilitate flow from the valve 82a to the valve 83a. In further examples, the recirculation path 85a may also include a holding tank to store the brine solution 100 before being recirculated.

In an example of the operation of the apparatus 50a, the apparatus 50a may initially receive a brine solution 100 at the inlet 60a from an external source. The brine solution 100 is to include dissolved lithium and a dissolved waste element. The valve 83a is configured to connect the inlet 60a to the cavitation chamber 55a. An ion solution is injected into the flow by the injector 70a to form a precipitate with the target waste element. The brine solution 100 is then processed in the cavitation chamber 55a to precipitate the dissolved waste elements while not affecting the dissolved lithium. The precipitate is then filtered out of the mixture 120 of brine solution and waste precipitation by the filtration unit 80a leaving a brine solution without the targeted waste element. The valve 82a may then direct the brine solution without the targeted waste element to the recirculation path 85a where it may be stored until it is to be re-processed. Once the brine solution without the targeted waste element is to be reprocessed, the valve 83a will close the flow of brine solution from the inlet 60a and direct the brine solution without the targeted waste element in the recirculation path 85a to the cavitation chamber 55a. Along the way, the injector 70a may inject another ion, such as a phosphate, carbonate, or hydroxide ion, capable of forming a lithium precipitate with the dissolved lithium. The filtration unit 80a may then be used to collect the lithium precipitate for further processing. It is to be appreciated by a person of skill with the benefit of this description that the ion used to precipitate the lithium may be the same ion used to precipitate the waste element. This may be possible if the ion selected forms a waste precipitate with a significantly lower solubility than the lithium precipitate.

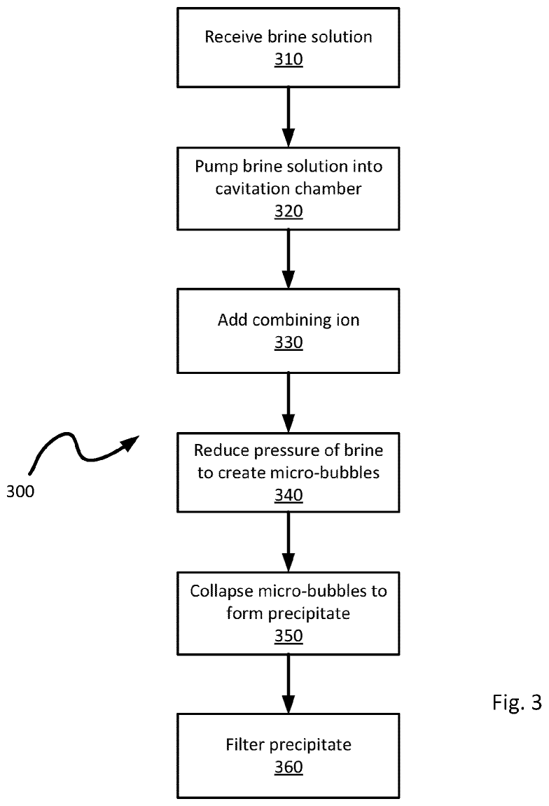

Referring to FIG. 3, a flowchart of an example method of extracting lithium from a brine solution 100 containing dissolved lithium and a waste element is generally shown at 300. In order to assist in the explanation of method 300, it will be assumed that method 300 may be performed by the apparatus 50. Indeed, the method 300 may be one way in which the apparatus 50 may operate.

Beginning at block 310, a brine solution 100 containing dissolved lithium and a waste element is to be received at an inlet 60. The manner by which the brine solution 100 is received is not particularly limited and may involve being pumped brine solution from a source that has a positive pressure. The brine solution is then pumped into the cavitation chamber 55 at block 320. In the present example, the pressure at which the brine solution 100 enters the cavitation chamber is to be maintained at a substantially constant target pressure. The predetermined target pressure is not particularly limited and may be selected to increase the performance of the micro-bubble generator 75. Since the dimensions of the system are generally fixed, the pressure may be controlled by measuring and controlling the flow rate of the brine solution 100 into the cavitation chamber 55.

Block 330 involves adding a combining ion to the flow of the brine solution 100 between the inlet 60 and the cavitation chamber 55. The combining ion is to be used in the cavitation chamber 55 to react with the dissolved waste element to form a waste precipitate.

Next, block 340 comprises reducing the pressure in localized regions of the brine solution 100 as it passes through the micro-bubble generator 75 to a pressure that is below the value of the vapor pressure of the brine solution 100. By reducing the pressure below the vapor pressure, micro-bubbles 110 are created in the brine solution 100. The manner by which the micro-bubble generator 75 reduces localized pressure in regions is not particularly limited. In the present example, the micro-bubble generator 75 is a hydrodynamic cavitation reactor having a blade moving at a high speed through the brine solution 100 to create localized regions of low pressure as the blade passes through.

Block 350 comprises collapsing the micro-bubbles 110 as they move away from the region of localized low pressure and return to the normal pressure of the brine solution 100. Upon collapsing, the micro-bubbles 110 release localized energy that can facilitate the separation of the components of the brine solution 100 to form a waste precipitate which can be filtered out at block 360.

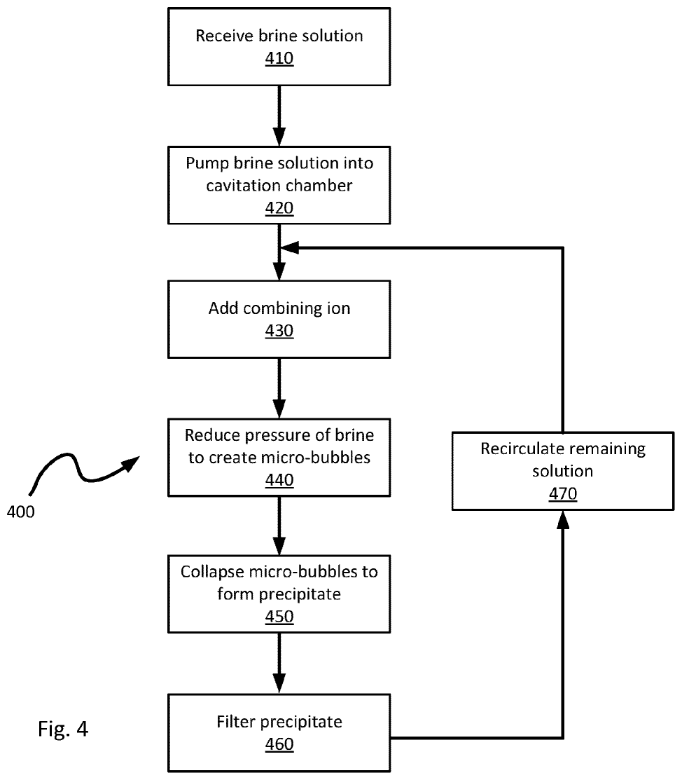

Referring to FIG. 4, a flowchart of another flowchart of an example method of extracting lithium from a brine solution 100 containing dissolved lithium and a waste element is generally shown at 400. In order to assist in the explanation of method 400, it will be assumed that method 400 may be performed by the apparatus 50a. Indeed, the method 400 may be one way in which the apparatus 50a may operate.

Beginning at block 410, a brine solution 100 containing dissolved lithium and a waste element is to be received at an inlet 60a. The brine solution 100 is then pumped into the cavitation chamber 55a at block 420 at a substantially constant target pressure. A combining ion is added to the flow of the brine solution 100 between the inlet 60a and the cavitation chamber 55a at block 430. The combining ion is to be used in the cavitation chamber 55a to react with the dissolved waste element to form a waste precipitate. Block 440 comprises reducing the pressure in localized regions of the brine solution 100 as it passes through the micro-bubble generator 75a to a pressure that is below the value of the vapor pressure of the brine solution 100. By reducing the pressure below the vapor pressure, micro-bubbles 110 are created in the brine solution 100.

Block 450 comprises collapsing the micro-bubbles 110 as they move away from the region of localized low pressure and return to the normal pressure of the brine solution 100. Upon collapsing, the micro-bubbles 110 release localized energy that can facilitate the separation of the components of the brine solution 100 to form a waste precipitate which can be filtered out at block 460.

The remaining brine solution with the waste element substantially removed may then be recirculated back to the cavitation chamber 55a at block 470. Along the path back to the cavitation chamber 55a, additional combining ions may be added to the brine solution. During the second pass of the brine solution without the waste element, a combining ion may be added to form a lithium precipitate via the same process described in block 440 and block 450. The lithium precipitate may then be collected via a filtration process, such as the one described in block 360 or block 460.

It should be recognized that features and aspects of the various examples provided above may be combined into further examples that also fall within the scope of the present disclosure.

1. A method of removing a waste element from a brine solution, the method comprising:
receiving the brine solution comprising dissolved lithium and a waste element;
pumping the brine solution into a cavitation chamber;
adding a combining ion to the brine solution, wherein the combining ion is to form a waste precipitate with the waste element;
reducing a pressure of the brine solution in the cavitation chamber as the brine solution moves away from an inlet, wherein the pressure is reduced to below a fluid vapor pressure of the brine solution to create micro-bubbles;
collapsing the micro-bubbles to generate a localized energy release, wherein the localized energy release accelerates formation of a waste precipitate from the waste element and combining ion to provide a mixture of the brine solution and the waste precipitate; and
filtering the waste precipitate to remove the waste element from the mixture.

2. The method of claim 1, wherein the waste element is magnesium.

3. The method of claim 1, wherein the waste element is calcium.

4. The method of claim 1, wherein the combining ion is to form an additional waste precipitate with an additional waste element.

5. The method of claim 1, wherein the combining ion is one of a hydroxide ion, a carbonate ion, and a phosphate ion.

6. The method of claim 1, further comprising:
recirculating the brine solution to the cavitation chamber after removing the waste element from the brine solution;
forming a lithium precipitate;
reducing the pressure of the brine solution in the cavitation chamber as the brine solution moves away from the inlet to create a second plurality of micro-bubbles;
collapsing the second plurality of micro-bubbles to generate a second localized energy release, wherein the second localized energy release causes the dissolved lithium to form the lithium precipitate; and
collecting the lithium precipitate.

7. The method of claim 6, wherein forming the lithium precipitate comprises adding the combining ion to the brine solution, wherein the combining ion is to form the lithium precipitate with the dissolved lithium, and wherein the lithium precipitate is more soluble than the waste precipitate.

8. An apparatus comprising:
a cavitation chamber;
an inlet to receive a brine solution comprising dissolved lithium and a waste element;
a pump to pump the brine solution from the inlet into the cavitation chamber at a predetermined pressure;
an injector to inject an ion solution with a combining ion into a flow of the brine solution;
a micro-bubble generator disposed within the cavitation chamber to create micro-bubbles, wherein the micro-bubble generator reduces a pressure of the brine solution below a fluid vapor pressure, and wherein the micro-bubbles collapse to release localized energy, wherein the localized energy accelerates formation of a waste precipitate from the waste element and combining ion to provide a mixture of the brine solution and the waste precipitate; and
a filtration unit to remove the waste precipitate from the mixture.

9. The apparatus of claim 8, wherein the brine solution received at the inlet includes dissolved magnesium.

10. The apparatus of claim 8, wherein the brine solution received at the inlet includes dissolved calcium.

11. The apparatus of claim 8, wherein the ion solution injected forms an additional waste precipitate with an additional waste element.

12. The apparatus of claim 8, wherein the injector injects one of a hydroxide ion, a carbonate ion, and a phosphate ion.

13. The apparatus of claim 8, further comprising a recirculation path to connect the filtration unit to the inlet to deliver the brine solution to the cavitation chamber after removing the waste element from the brine solution, wherein the cavitation chamber is to form a lithium precipitate.

14. The apparatus of claim 13, wherein the filtration unit is to collect the lithium precipitate.

15. The apparatus of claim 14, wherein the combining ion is to form the lithium precipitate with the dissolved lithium, and wherein the lithium precipitate is more soluble than the waste precipitate.
